(19) United States
(12) Patent Application Publication
(10) Pub. No.: US 2004/0178663 A1
(43) Pub. Date: Sep. 16, 2004

(54) System and method for extending the sleeper cab of a tractor trailer truck

(76) Inventor: Robert Whelan, New Hope, PA (US)

Correspondence Address: Eric A. LaMorte, LaMorte & Associates, P.C., P.O. Box 434, Yardley, PA, 19067-8434, US

(21) Appl. No.: 10/384,025

(22) Filed: Mar. 10, 2003

(51) Int. Cl. B62D 33/06

(52) U.S. Cl. 296/190.02

(57) ABSTRACT

A sleeper cab assembly for a tractor-trailer truck. The sleeper cab assembly has a primary sleeper cab structure that is positioned behind the driver cab of the tractor-trailer. The primary sleeper cab structure has a rear wall, wherein an opening is disposed in the rear wall. A door is coupled to the rear wall for selectively opening and closing the rear wall opening. The door is selectively positionable between a vertical position, where the door obstructs the opening, and a horizontal position where the door does not obstruct the opening. An enclosure is provided for covering an area above the door when the door is in its horizontal position. The door and its covering define a secondary chamber that is accessible from the interior of the sleeper cab structure through the opening in the rear wall.

### BACKGROUND OF THE INVENTION

1. Field of the Invention

In general, the present invention relates to the structure of tractor-trailer trucks. More particularly, the present invention relates to the structure of the sleeper cab portion of a tractor-trailer truck.

2. Prior Art Statement

Most goods in the United States are transported from point-to-point using trucks. The most common type of trucks used to haul large quantities of goods are tractor-trailer trucks. A tractor-trailer truck is the general name given to trucks specifically designed to pull cargo trailers. Tractor-trailer trucks and cargo trailers come in a wide variety of shapes and styles. However, in the most common configuration, a cargo trailer is a trailer that has no front wheels and eight rear wheels. The tractor-trailer truck itself has ten wheels and supports the front of the trailer. Accordingly, when the tractor-trailer truck is connected to a cargo trailer, the overall vehicle has eighteen wheels. Accordingly, such vehicles are commonly referred to as “eighteen wheelers” or “tractor trailers” in common speech.

Tractor-trailer trucks come in a wide variety of models and styles depending upon the needs of a user. Two types of tractor-trailer trucks include short cab trucks and sleeper cab trucks. Tractor-trailer trucks that are used to make short hauls, or are often driven on city streets, are typically short cab trucks. In a short cab truck, there is a driver's bench and very little room behind the driver's bench. This shortens the overall length of the tractor-trailer truck and enables the tractor-trailer truck to make narrow turns in tight traffic. However, tractor-trailer trucks that are driven long distances over the nation's highways typically are sleeper cab trucks. A sleeper cab style tractor-trailer truck has a sleeper cab behind the driver's bench. This provides the driver with a place to sleep at night so that the driver does not have to check into a motel every night during a long haul.

The size of a typical sleeper cab on a tractor-trailer truck is typically less than six feet. The reason for this is that the longer the sleeper cab is made, the longer the frame of the tractor-trailer truck must be made. The longer the tractor-trailer truck's frame is made, the more room that tractor-trailer truck needs on a street to turn. Accordingly, if the sleeper cab is made much longer than six feet, a tractor-trailer truck would not be able to make certain turns commonly found between narrow roads.

In the small amount of space within a sleeper cab, there is typically contained a toilet, a sink, storage cabinets and a sleeping bunk. The sleeping bunk is typically folded flush against a wall to save space when not in use. When the sleeper bunk is to be used, a driver commonly must rearrange the contents of the sleeper cab to make enough room so that the sleeping bunk can be deployed into its horizontal position. Commonly, when the sleeping bunk is deployed, its structure blocks the sink and/or toilet. Accordingly, if a driver wants to use the sink or the toilet in the middle of the night, the sleeping bunk must first be moved back into its stowed orientation.

When a tractor-trailer truck is connected to a cargo trailer, there is a minimum amount of articulation space that must be left open between the back of the sleeper cab and the front of the cargo trailer. This articulation space is typically between three and five feet. The reason this articulation space must be left open is that this open space is needed to prevent the structure of the sleeper cab from contacting the cargo trailer when the tractor-trailer truck pivots while making sharp turns. Accordingly, if a person were to design a longer sleeper cab, the frame of the tractor-trailer truck would have to be made longer in order to preserve the required minimum open articulation space required between the sleeper cab and the cargo trailer. As has been previously mentioned, a tractor-trailer truck with a longer frame is highly undesirable because it greatly limits the ability of the tractor-trailer truck to turn on narrow roadways.

A need therefore exists for a system and method that increases the size of a sleeper cab without requiring a corresponding increase in length in the frame of the tractor-trailer truck. This need is met by the present invention as described and claimed below.

### SUMMARY OF THE INVENTION

The present invention is a sleeper cab assembly for a tractor-trailer truck. The sleeper cab assembly has a primary sleeper cab structure that is positioned behind the driver cab of the tractor-trailer. The primary sleeper cab structure has a rear wall, wherein an opening is disposed in the rear wall. A door is coupled to the rear wall for selectively opening and closing the rear wall opening. The door is selectively positionable between a vertical, position, where the door obstructs the opening, and a horizontal position where the door does not obstruct the opening. An enclosure is provided for covering an area above the door when the door is in its horizontal position. The door and its covering define a secondary chamber that is accessible from the interior of the sleeper cab structure through the opening in the rear wall.

The secondary chamber is deployed when the tractor-trailer is parked. The secondary chamber extends into the articulation zone between the sleeper cab and the cargo trailer which is acceptable when the tractor-trailer is parked. The sleeper cab is typically only used when the tractor-trailer is parked. Accordingly, the space in the sleeper cab can be expanded when needed. The secondary chamber is retracted when the driver leaves the sleeper cab and again begins to drive. As such, nothing remains in the articulation zone that can interfere with the ability of the tractor-trailer to turn.

### BRIEF DESCRIPTION OF THE DRAWINGS

For a better understanding of the present invention, reference is made to the following description of exemplary embodiments thereof, considered in conjunction with the accompanying drawings, in which:

FIG. 1 is a side view of a tractor-trailer having the sleeper cab configuration of the present invention shown in a retracted position;

FIG. 2 is a side view of a tractor-trailer having the sleeper cab configuration of the present invention shown in a deployed position;

FIG. 3 is a selectively cross-sectioned view of the segment of FIG. 2 containing the sleeper cab and the articulation zone behind the sleeper cab;

FIG. 4 is a side view of the exterior of the sleeper cab when the extending section is deployed; and

FIG. 5 is a cross-sectional view of an alternate embodiment of the present invention sleeper cab configuration.

### DETAILED DESCRIPTION OF THE INVENTION

The present invention is a system and method for extending the sleeper cab of a tractor-trailer into the unused articulation zone that is present between the sleeper cab and the front of a cargo trailer. Since the articulation zone is unimportant when the tractor-trailer is parked, this space can be temporarily utilized to expand the sleeper cab when the driver of the truck is not driving and is using the sleeper cab. Once the driver is ready to drive, the extended sleeper cab is retracted and the articulation zone is again unused.

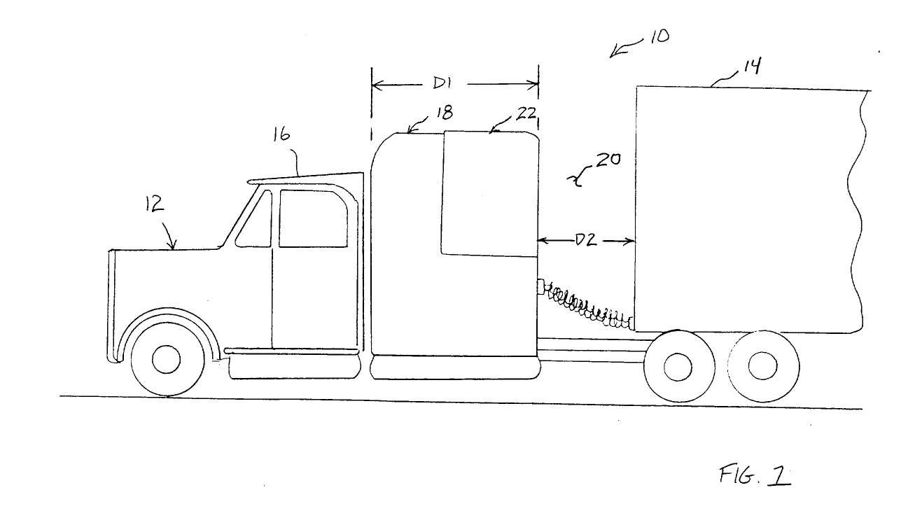

Referring to FIG. 1, a tractor-trailer 10 is shown. The tractor-trailer 10 contains a tractor-trailer truck 12 that is pulling a cargo trailer 14. The tractor-trailer truck 14 has a driver cab 16 in which the driver sits when driving the tractor-trailer 10. Behind the driver cab 16 is a sleeper cab 18 that is used by the driver when the driver is resting. The sleeper cab 18 has the same width as does the driver cab 18 and extends a predetermined distance D1 behind the driver cab 16. The predetermined distance D1 can be any distance between two feet and ten feet, with the average sleeper cab extending approximately six feet behind the driver cab 16.

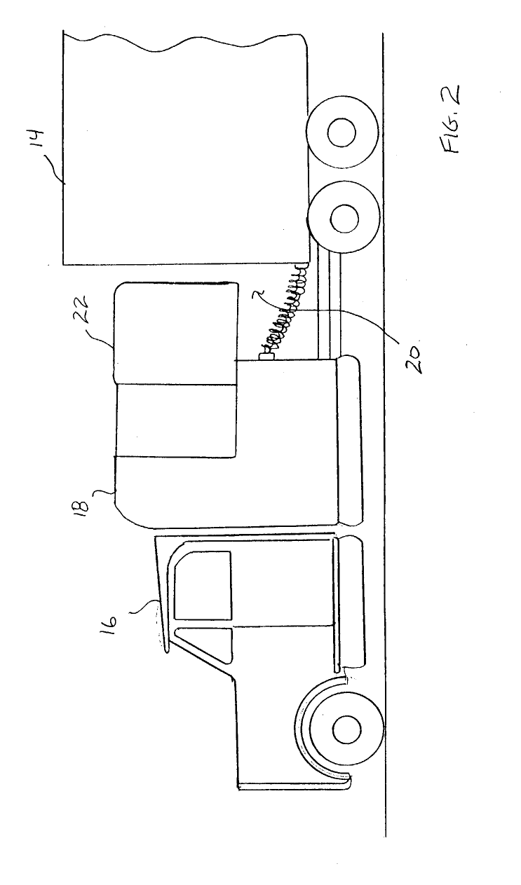

The articulation zone 20 between the rear of the sleeper cab 18 and the front of the cargo trailer 14 has a predetermined distance D2, which is at least three feet. As can be seen by now referring to both FIG. 1 and FIG. 2, an extendable section 22 of the sleeper cab 18 is selectively deployable between a retracted position and a deployed position. FIG. 1 shows the sleeper cab 18 having the extendable section 22 in a retracted position. When the extendable section 22 of the sleeper cab 18 is in its retracted position, the articulation zone 20 between the sleeper cab 18 and the cargo trailer 14 is left unoccupied. However, referring to FIG. 2, the extendable section 22 of the sleeper cab 18 is shown in a deployed configuration. When in the deployed configuration, the extendable section 22 of the sleeper cab 18 now extends into the articulation zone 20.

The articulation zone 20 between the sleeper cab 18 and the cargo trailer 14 need only be left empty when the tractor-trailer 10 is being driven. When the tractor-trailer 10 is being driven, the driver is in the driver cab 16, not in the sleeper cab 18. However, when a driver parks the tractor-trailer 10 to rest, the articulation zone 20 between the sleeper cab 18 and the cargo trailer 14 is unutilized space. Consequently, the extendable section 22 can be moved into its deployed configuration, as is shown in FIG. 2.

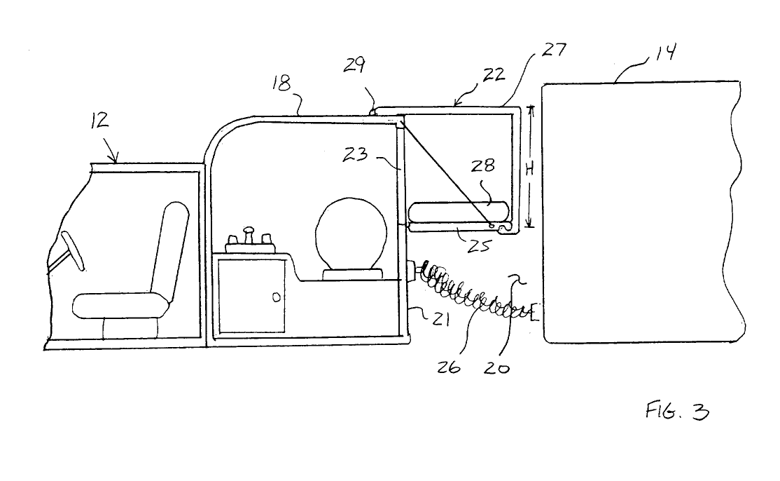

Referring to FIG. 3, it can be seen that within the sleeper cab 18, there may be a toilet, a sink or other objects neatly arranged in the confined space. The extendable section 22 extends from the rear wall of the sleeper cab 18 toward the cargo trailer 14. In the shown embodiment, the extendable section 22 has a height H1 that is less than the height of the entire sleeper cab 18. Accordingly when the extendable section 22 is moved into its deployed position, a space exists under the extendable section 22 in the articulation zone 20. In many models of tractor-trailer trucks, pneumatic couplings, pneumatic hoses and electrical cables interconnect the tractor-trailer truck 12 to the brakes and lights of the cargo trailer 14. These hoses and cables 26 extend into the articulation zone 20 from the middle of the sleeper cab 18. By having the extendable section 22 extend into the articulation zone 20 only from the top half of the sleeper cab 18, the extendable section 22 does not interfere with the hoses and cables 26.

In the rear wall 21 of the sleeper cab 18, there is an opening 23. The opening 23 is covered by a door 25. The door 25 is hinged at the bottom. Accordingly, the door 25 can rotate about its hinge from a vertical orientation to a horizontal orientation. When the door 25 is in its vertical position, the door 25 covers the opening 23 in the rear wall 21. However, when the door 25 is rotated down into its horizontal orientation, the door 25 extends horizontally behind the rear wall 21 of the sleeper cab 18.

The extendable section 22 is comprised of the door 25 and a shell 27 that encloses the area over the door 25 when the door is in its horizontal orientation. In the shown embodiment, the shell 27 is a rigid four-sided structure that surrounds the exposed sides of the top of the door 25. The shell 27 and the door 25 combine to produce a secondary enclosure that is only accessible from the inside of the sleeper cab 18.

The space added to the sleeper cab 18 that is made by moving the extendable section 22 into its deployed configuration can be used for any purpose. However, the space added by the deployment of the extendable section 22 is well suited for containing a sleeping bunk 28. In the embodiment of FIG. 3, it can be seen that a bunk 28 can be pivotally mounted to the interior of the door 25. When the extendable section 22 is deployed, the bunk 28 folds into the horizontal with the door 25 so that it can be utilized. Since the bunk 28 is located in the space added by the deployment of the extendable section 22, the presence of the bunk 28 does not interfere with the toilet or any other item contained within the sleeper cab 18.

Since, the exterior of the extendable section 22 will be exposed to the elements, it will be understood that weather stripping 29 is used at the joints between the extendable section 22 and the main body of the sleeper cab 18. The weather stripping 29 prevents rain from seeping through the joints and entering the sleeper cab 18.

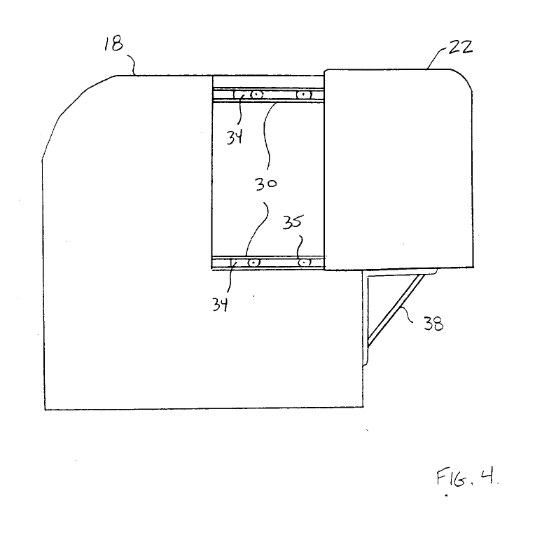

Referring to FIG. 4, it can be seen that when the extendable section 22 is deployed into the articulation zone 20, the extendable section 22 forms a cantilevered structure that is supported only by its attachment to the sleeper cab 18. To support the weight of a person sleeping within the extendable section 22, supports are provided. There are many supporting structures that can be used. In the embodiment of FIG. 4, two types of supporting structures are shown. One type of supporting structure that can be used includes sliding rail assemblies 30. The sliding rail assemblies 30 are much like the rails used on the sides of a cabinet draw. The rail assemblies 30 include an external rail 32 that is bolted to the walls of the sleeper cab 18. A sliding rail 34 passes into the external rail 32 and may contain wheels 35 so that the sliding rail 34 can move freely along the inside of the external rail 32. The slider rail 34 is rigidly affixed to the structure of the extendable section 22, thereby providing support to the extendable section 22.

A second type of support structure shown in FIG. 4 includes support brackets 38. The support brackets 38 support the bottom of the extendable section 22 when the extendable section 22 is deployed. The support brackets 38 may be connected to the bottom of the extendable section 22 with a hinged joint. This allows the support brackets 38 to fold away and fall into place when the extendable section 22 is deployed. Alternatively, the support brackets 38 can be attached to the rear of the sleeper cab 18 and can rotate out into position when needed. In yet another embodiment, the support brackets 38 can be removable elements that are set in place by the driver before the extendable section 22 is deployed.

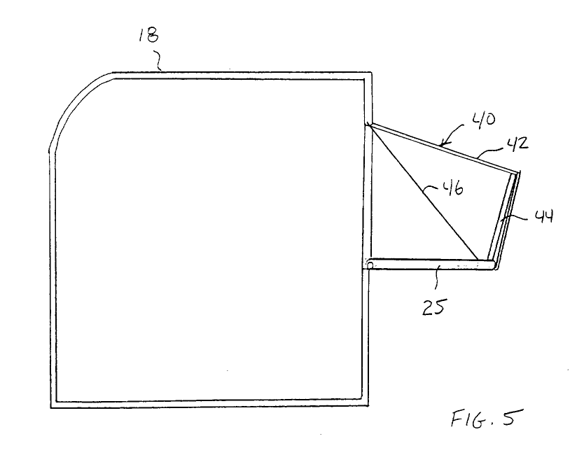

In the embodiment of FIG. 4, it can be seen that the extendable section 22 includes the use of a rigid shell 27 that encapsulates the space over the door 25. Such an embodiment is preferred for use in cold or-inclement weather. However, a fabric or mesh structure can alternatively be used. Referring to FIG. 5, it can be seen that flexible tent walls 42 are provided for the sides and top of the shell 40. A tent pole 44 can be used to support the top corner of the: tent's structure, to form the shell 40. Support wires 46 can be used to support the door 45 when it is deployed horizontally.

Such an embodiment is very inexpensive to manufacture and can be retroactively added to existing sleeper cabs. However, since this embodiment has only fabric walls, a driver would only use it during warm, fair weather conditions.

It will be understood that the system and method of the present invention described and illustrated are merely exemplary and a person skilled in the art can make many variations to the shown embodiment. All such alternate embodiments and modifications are intended to be included within the scope of the present invention as defined below in the claims.

What is claimed is:

1. A sleeper cab assembly for a tractor-trailer truck, comprising:
a cab structure having a rear wall, wherein an opening is defined in at least part of said rear wall;
an extendible section coupled to said cab structure, said extendable section being selectively positionable between a deployed position and a retracted position, wherein when in said retracted position at least part of said extendable section obstructs said opening in said rear wall of said cab structure, and when in said deployed position, said extendable section defines a secondary chamber behind said rear wall that is accessible from within said cab structure through said opening in said rear wall.

2. The assembly according to claim 1, wherein said cab structure has an exterior surface and said extendable section includes a rigid shell structure that overlaps at least part of said exterior surface when in said retracted position.

3. The assembly according to claim 1, further including a support structure for supporting said extendable section when said extendable section is in said deployed position.

4. The assembly according to claim 3, wherein said support structure is selected from a group consisting of brackets, rails and wires.

5. The assembly according to claim 1, further including a sleeping bunk coupled to said extendable section wherein said sleeping bunk is disposed in said secondary chamber when said extendable section is in said deployed position.

6. The assembly according to claim 1, wherein said secondary chamber defined by said extendable section has wall sections and a top section, wherein said wall sections and said top section are comprised of flexible fabric.

7. The assembly according to claim 1, further including support poles for supporting said wall sections and said top section in a fixed orientation when said extendable section is in said deployed position.

8. In a tractor trailer truck having a sleeper cab with a rear wall, a method of selectively increasing the space within the sleeper cab, comprising the steps of:
providing a structure to said sleeper cab that can be selectively oriented between a retracted condition and a deployed condition, wherein when in said deployed condition, said structure defines a secondary chamber adjacent said sleeper cab that is accessible from the interior of the sleeper cab;
selectively changing said structure from said retracted condition to said deployed condition when said tractor trailer truck is parked and a person desires to increase space available within said sleeper cab to include said secondary chamber.

9. The method according to claim 8, further including the step of positioning a sleeping bunk in said secondary chamber when in said deployed condition.

10. The method according to claim 8, wherein said secondary chamber is disposed behind said rear wall of said sleeper cab when in said deployed condition.

11. The method according to claim 8, wherein said step of selectively orienting said structure from said retracted position to said deployed position includes the substeps of:
folding a section of said rear wall into a horizontal orientation; and
positioning walls around said section of said rear wall and a top over said walls to produce said secondary chamber.

12. The method according to claim 11, wherein said substep of positioning walls includes advancing a rigid shell over said section of rear wall.

13. The method according to claim 12, wherein said substep of positioning walls includes forming a tent structure over said section of said rear wall.

14. A sleeper cab assembly for a tractor-trailer truck, comprising:
a sleeper cab structure having a rear wall, wherein an opening is disposed in said rear wall;
a door coupled to said rear wall for closing said opening, wherein said door is selectively positionable between a vertical position, where said door obstructs said opening and a horizontal position where said door does not obstruct said opening;
an enclosure for covering an area above said door when said door is in said horizontal position, said door and said covering defining a secondary chamber that is accessible through said opening in said rear wall.

15. The assembly according to claim 14, further including at least one support element for supporting said door in said horizontal position.

16. The assembly according to claim 15, wherein said at least one support element is selected from a group consisting of brackets, wires, and rails.

17. The assembly according to claim 14, wherein said enclosure is a rigid shell.

18. The assembly according to claim 14, wherein said enclosure is a tent structure.
